(19) United States
(12) Patent Application Publication
(10) Pub. No.: US 2025/0029171 A1
(43) Pub. Date: Jan. 23, 2025

(54) USING MACHINE LEARNING TO OPTIMIZE UNITS OF MEASURE REPRESENTATIONS

(71) Applicant: ADOBE INC., SAN JOSE, CA (US)

(72) Inventors: Soumya UNNIKRISHNAN, Austin, TX (US); Michele SAAD, Austin, TX (US)

(21) Appl. No.: 18/355,880

(22) Filed: Jul. 20, 2023

(51) Int. Cl. G06Q 30/0601

(52) U.S. Cl. CPC G06Q 30/0641

(57) ABSTRACT

Methods and systems are provided for using machine learning to optimize UoM representations. In embodiments described herein, units of measure (UoMs) and relationships of each of UoMs to textual representations of each of the UoMs are stored in a knowledge graph. Text corresponding to a measurement of a product is extracted by an inference model. A recommended textual representation of the measurement of the product by is determined by an autoencoder model including a corresponding textual representation of one of the UoMs from the textual representations of the one of the UoMs stored in the knowledge graph. The recommended textual representation of the measurement of the product is then displayed.

### BACKGROUND

Representation of units of measure is critical to ecommerce systems. However, units of measure often vary across ecommerce systems. For example, units of measure can be represented in multiple measurement systems, such as the International System of Units (SI), the United States customary system (US), the British imperial system (imperial), etc.). In some instances, representations of units of measure may have symbols that are ambiguous. Further, ecommerce businesses often do not follow a standard representation for product attributes. Similarly, for search queries performed by ecommerce shoppers, there is no standard way of representing units of measure in search queries. Such ambiguities and omissions in both product catalogs and search queries can lead to errors in procurement, higher return rates, and lower conversions for ecommerce businesses.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for, among other things, using machine learning to optimize units of measure (UoM) representations for search queries. In this regard, embodiments described herein facilitate using machine learning to optimize UoM representations by utilizing a UoM representation recommender machine learning model that is trained to recommend UoM representations for a product description or a search query based on context, such as the business model, industry vertical, geo-location of the market, product catalog data, shopper behavior data, etc. In some embodiments, the UoM representation recommender machine learning model is utilized to normalize UoM representations presented in a search query and normalize UoM representations of product attributes in a product catalog for indexation in order to optimize search and ranking in search engines. As well, in some embodiments, the UoM representation recommender machine learning model is utilized with a generative model to generate new attribute names for products or taxonomies for groups of products based on corresponding UoM representations.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example diagram of an example UoM representation recommender system, in accordance with embodiments of the present disclosure.

FIG. 4 provides an example diagram of an example generating UoM representation suggestions for a product catalog, in accordance with embodiments of the present disclosure.

FIG. 5 provides an example diagram of an example generating UoM representation suggestions for shopper search queries, in accordance with embodiments of the present disclosure.

FIG. 6A provides an example diagram of an example normalizing UoM representations for search queries, in accordance with embodiments of the present disclosure.

FIG. 6B provides an example diagram of an example normalizing UoM representations for product attributes, in accordance with embodiments of the present disclosure.

FIG. 6C provides an example diagram of an example normalizing UoM representations in a search engine, in accordance with embodiments of the present disclosure.

FIG. 7 provides an example diagram of an example generating UoM representation attributes from a product description, in accordance with embodiments of the present disclosure.

FIG. 8 provides an example diagram of an example generating taxonomies from UoM representations from product descriptions in a product catalog, in accordance with embodiments of the present disclosure.

FIG. 9 is a process flow showing a method for recommending UoM representations to optimize product search queries, in accordance with embodiments of the present disclosure.

FIG. 10 is a process flow showing another method for generating UoM representation suggestions for shopper search queries in order to optimize the search queries, in accordance with embodiments of the present disclosure.

FIG. 11 is a process flow showing another method for generating UoM representation attributes and/or taxonomies from product descriptions in order to optimize search query results and/or web page navigation to find a product, in accordance with embodiments of the present disclosure.

FIG. 12 is a block diagram of an example computing device in which embodiments of the present disclosure can be employed.

### DETAILED DESCRIPTION

### Overview

Representation of units of measure (referred to herein as “UoM” or “units”) is critical to ecommerce systems. However, representation of UoMs often vary across ecommerce systems. For example, UoMs can be represented in multiple measurement systems (e.g., the International System of Units (SI), the United States customary system (US), the British imperial system (imperial), etc.). In some instances, UoM representations may have symbols that are ambiguous. For example, “g” may refer to “gram” or “gigabyte.” Further, ecommerce businesses (referred to herein interchangeably as merchandizers and businesses) often do not follow a standard representation for product attributes. For example, width may be represented as “64½ inch,” “64.5″,” or “164 cm” and “grams” may be represented as “G,” “GS” “GMS,” or even omitted. Similarly, for search queries performed by ecommerce shoppers (referred to herein interchangeably as customers or shoppers), there is no standard way of representing units in search queries. For example, a customer may search for a “4 oz brake fluid” or “120 ml brake fluid,” but results to the search queries will not be the same even though the both queries are searching for the same size brake fluid albeit in different measurement systems. Such ambiguities and omissions in both product catalogs and search queries can lead to errors in procurement, higher return rates, and lower conversions for ecommerce businesses.

Currently, in order for a customer to search for a product, the customer must guess at the correct UoM representation. Similarly, a business must predict at a UoM representation that a customer may utilize in their search queries. As a result of UoM representation not matching between search queries of customers and the product descriptions by businesses, the search results may fail to provide search results with products that would otherwise meet the customer's search criteria. The customer must then perform multiple search queries in order to identify a product that the customer is searching for or the customer may need to perform additional search queries on other websites. Not only is generation of search queries time-consuming and inaccurate, customers may have to click through products that do not meet the customer's search criteria and perform manual conversions to determine whether the products might meet their criteria further increasing time and decreasing efficiency of the search query.

Accordingly, unnecessary computing resources are utilized for customers performing search queries for products in conventional implementations. For example, computing and network resources are unnecessarily consumed to facilitate the search queries and accesses to products and product descriptions. For instance, computer input/output operations are unnecessarily increased in order for a customer to identify a product when the UoM representation provided in the product description does not match the UoM representation in the customer's search query. As one example, each time a search query is performed to identify a product with a specific UoM representation that the customer is searching, the information of the search query must be located at a particular computer storage address of a storage device. The information must then be retrieved from the particular computer storage address of the storage device and presented to the customer. The customer must review the results of the search query to determine whether the search results reflect the product with the correct measurement that the customer is searching. As the customer must perform multiple search queries on multiple platforms to identify products with the specific measurement that the customer is searching, computing resources are unnecessarily used to repeat the process for multiple iterations in order to submit new and/or different search queries, along with the subsequent accessing, presentation and review process of the information related to each iteration.

In this regard, the iterative process of searching for the product with a specific measurement and locating of the information by a search engine in order for the customer to review the search results is computationally expensive and increases latency. Further, when the information related to the product is located in a disk array and multiple iterations of the queries for the product in specific scenarios are issued, which is what occurs in existing technologies, there is unnecessary wear placed on the read/write head of the disk of the disk array. Further, the processing of the multiple iterations of search queries for products in specific measurements decreases the throughput for a network, increases the network latency, and increases packet generation costs. In this regard, usage of network resources is multiplied due to the amount of queries that must be executed by a customer searching a product with a specific measurement, the subsequent access of the information from the results of the queries, as well as the generation of metadata in TCP/IP or any protocol used to generate the queries and subsequently access/presentation of the information.

As such, embodiments of the present disclosure are directed to using machine learning to optimize UoM representations in an efficient and effective manner. In this regard, UoM representation can be recommended for product description or for a search query of a customer by a machine learning model trained to recommend UoM representations for product using context from shopper's UoM affinity, geo-location of the store, catalog's industry vertical, business model, product catalog content, etc.

Generally, and at a high level, embodiments described herein facilitate using machine learning to optimize UoM representations by utilizing a UoM representation recommender machine learning model that is trained to recommend UoM representations for a product description or a search query based on context, such as the business model, industry vertical, geo-location of the market, product catalog data, shopper behavior data, etc. In some embodiments, the UoM representation recommender machine learning model is utilized to normalize UoM representations presented in a search query and normalize UoM representations of product attributes in a product catalog for indexation in order to optimize search and ranking in search engines. As well, in some embodiments, the UoM representation recommender machine learning model is utilized with a generative model to generate new attribute names for products or taxonomies for groups of products based on corresponding UoM representations.

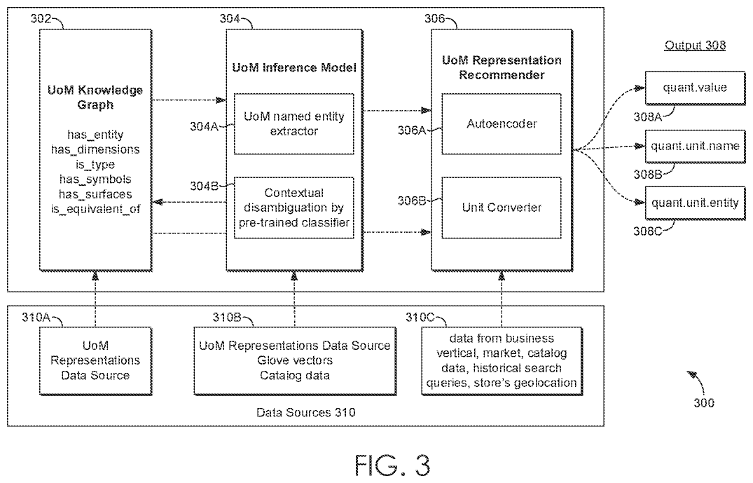

In operation, UoM representations and relationships are stored in a knowledge graph. For example, the UoM knowledge graph captures relationships (nodes) for a UoM, such as (1) the quantitative measure (e.g., length, mass, time, speed, etc.); (2) the dimensions of the quantitative measure (e.g., for derived units where speed equals length/time, the dimensions are length and time); (3) the type of measurement system (e.g., SI, US, imperial, etc.); (4) the symbols defined by the measurement system (e.g., feet, ft or ′, etc.); (5) the commonly occurring representations in the context of ecommerce (e.g., centimeter, centimeter, etc.); and/or (6) the conversion factor for other measurement systems (e.g., foot to meter: 0.3048). Embodiments of UoM knowledge graph 204 are described in further detail in relation to UoM knowledge graph 302 of FIG. 3.

A UoM inference model is configured to extract and classify UoM representations in product descriptions and/or search queries. In some embodiments, the UoM inference model uses named entity recognition methods to detect (e.g., extract) UoM representations (or missing UoM representations) in text. In some embodiments, the UoM inference model includes a pre-trained classifier for contextual disambiguation of UoM representations. For example, the pre-trained classifier learns UoM representations from data sources (e.g., the UoM knowledge graph, Wikipedia®, glove vector representations of UoMs, product catalog data, or any other source of data) in order to disambiguate between similar looking UoM representations based on the context in which they appear. Embodiments of UoM inference model 206 are described in further detail in relation to UoM inference model 304 of FIG. 3.

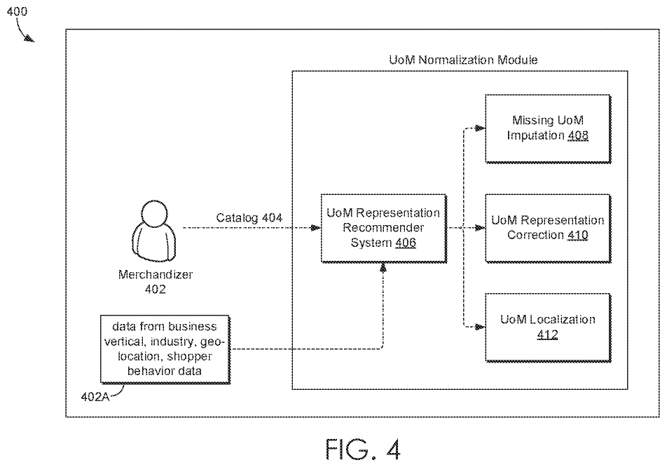

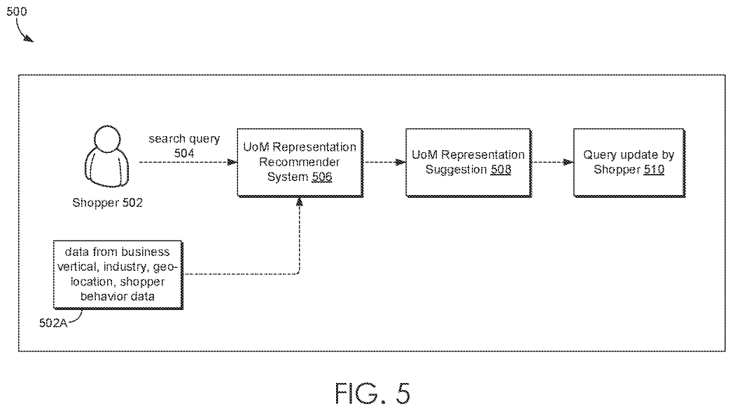

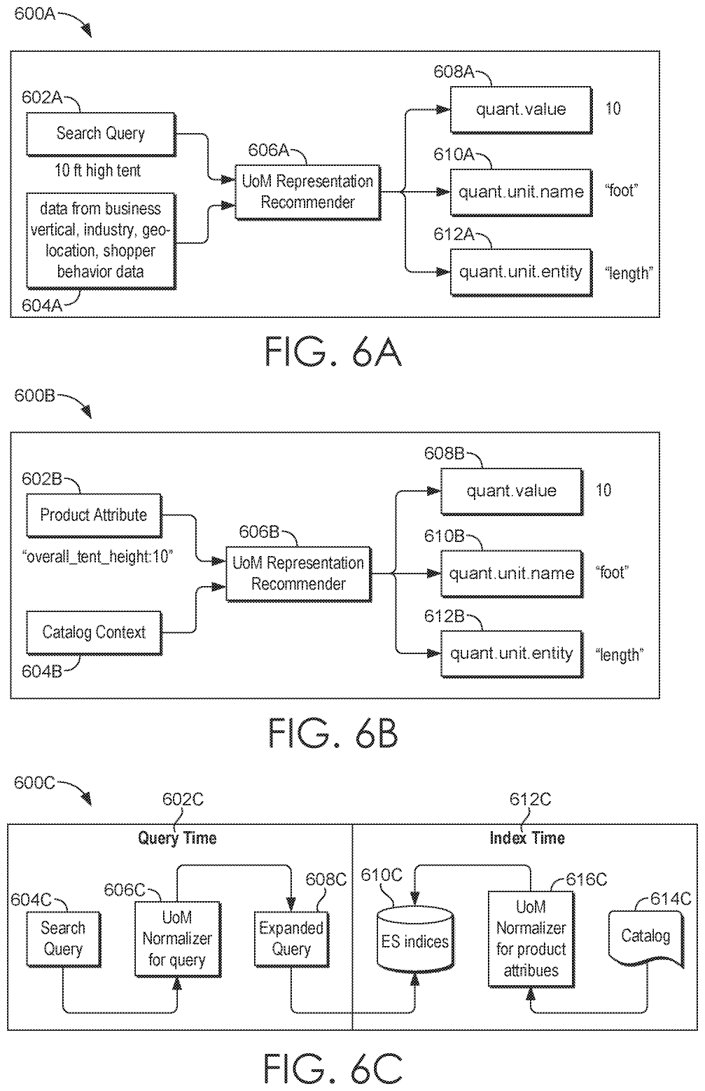

A UoM representation recommender machine learning model is generally configured to recommend the optimal UoM representation based on the UoM representations extracted by UoM inference model. In some embodiments, the UoM representation recommender engine includes an autoencoder that is trained to recommend UoM representations based on context, such as the business model, industry vertical, geo-location of the market, product catalog data, shopper behavior data, etc. With respect to an input product catalog, the UoM representation recommender machine learning model can perform missing UoM representation imputation, UoM representation correction, and/or UoM representation localization to present as recommendations to the business. With respect to a search query entered by a customer, the UoM representation recommender machine learning model provides recommendations for the UoM representations in the search query to optimize the search results. Embodiments of UoM representation recommender engine 208 are described in further detail in relation to UoM representation recommender 306 of FIG. 3, UoM representation recommender system 406 of FIG. 4, UoM representation recommender system 506 of FIG. 5, and UoM representation recommender system 606A-C and 616C of FIGS. 6A-C.

In some embodiments, a UoM representation search engine normalizer is configured to normalize UoM representations presented in a search query and normalize UoM representations of product attributes in a product catalog for indexation in order to optimize search and ranking in search engines. The UoM representation search engine normalizer normalizes UoM representations of the search query to match the normalized UoM representations of the product attributes of the products being searched resulting in optimized search query results. Embodiments of UoM representation search engine normalizer are described in further detail in relation to diagrams 600A-C of FIGS. 6A-C.

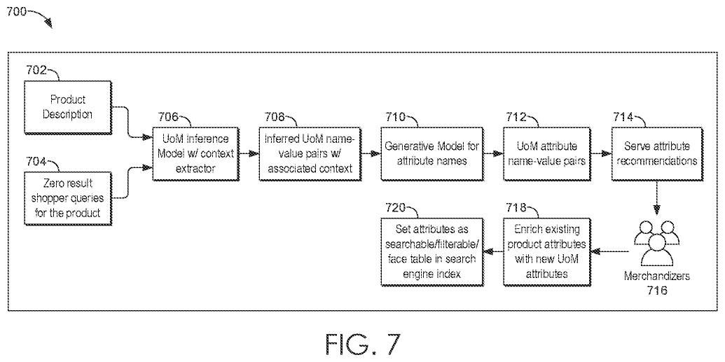

In some embodiments, a UoM representation attribute generator is generally configured to generate new attribute names for a product based on UoM representations of the product to improve the discoverability of the product in search engines. In embodiments, UoM representation attribute generator, through a UoM inference model, scans unstructured product details of a product description in catalogs of a product to identify name-value pairs of UoM representations with respect to product attributes. UoM representation attribute generator engine, through a generative model, generates new attribute names for the name-value pairs utilizing UoM name value pairs, the context from the product catalog, search query history, etc. in order to improve the discoverability of the product in search engines. Embodiments of UoM representation attribute generator are described in further detail in relation to diagram 700 of FIG. 7.

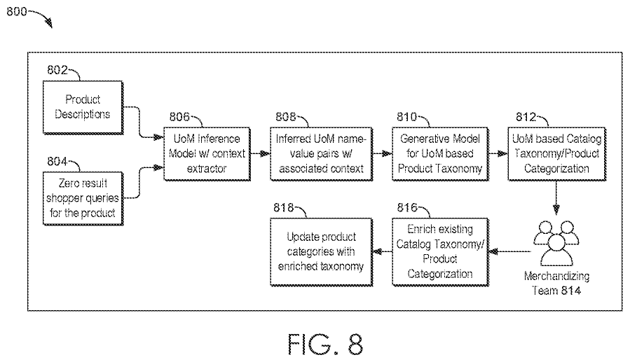

In some embodiments, the UoM representation taxonomy generator is configured to generate new or improved taxonomies (e.g., categories) for products in a product catalog based on UoM representations of the products to improve the discoverability of the product in search queries and/or web navigation to find a product. The UoM representation taxonomy generator, through a UoM inference model, scans product descriptions in product catalogs to identify name-value pairs of UoM representations with respect to product attributes. The UoM representation taxonomy generator, through a generative model, generates new or improved taxonomies based on the UoM name value pairs, the context from the product catalog, search query history, etc. in order to improve the discoverability of the product in search queries and/or web page navigation to find a product. Embodiments of UoM representation taxonomy generator engine 214 are described in further detail in relation to diagram 800 of FIG. 8.

Advantageously, efficiencies of computing and network resources can be enhanced using implementations described herein. In particular, the generating of recommended UoM representations for product descriptions and/or search queries based on contextual data results in a more efficient use of computing resources (e.g., higher throughput and reduced latency for a network, less packet generation costs, etc.) than conventional methods of UoM representations for product descriptions for indexing and searching for products. Further, the technology described herein enables a customer searching for a product with a specific measurement to be presented with the product with the specific measurement causing the customer to be more likely to purchase the product, which provides a more efficient use of computing resources by reducing the usage of network resources for performing unnecessary search query iterations. In this regard, the technology described herein enables a customer searching for a product with a specific measurement to be able to efficiently and effectively discover products with the specific measurement with minimal search queries, thereby reducing unnecessary computing resources used to process multiple search query iterations. The technology described herein results in less search queries over a computer network, which results in higher throughput, reduced latency and less packet generation costs as fewer packets are sent over a network. Therefore, the technology described herein conserves network resources.

Various terms are used throughout the description of embodiments provided herein. A brief overview of such terms and phrases is provided here for ease of understanding, but more details of these terms and phrases is provided throughout.

A “unit of measure” (UoM) is a standardized quantity that is used to express a physical or abstract property in order to quantify and compare values of the same attribute. Examples of UoMs include meters or feet for length, kilogram or pounds for mass, seconds for time, etc. A textual representation of a UoM (referred to interchangeably as a UoM representation) can include a word, abbreviation, a symbol (e.g., inches, in, or ″, etc.) or any other textual form to refer to a UoM. Taxonomies corresponding to UoMs refer to hierarchical classification system in order to categorize products based on similar UoMs or similar quantities of a UoM (e.g., categorizing tents based on the size of the tent—10′×10′ or 10′×20′, etc.).

A “product description” refers to text, images, and any other data describing the product or how the product is manufactured. The product descriptions can include various product attributes of a product. A “product attribute” refers to a specific characteristic of a product and certain product attributes may be expressed in terms of a UoM representation, such as the weight of a diamond in carat weight, the height of a tent in feet, etc. The product descriptions may be present in any type of database. The database of product descriptions may be referred to as a catalog, set, or listing of product descriptions. For example, the product descriptions may be stored in a product information management (PIM) system. A PIM system refers to software designed to centralize, manage, and distribute product information regarding products for a business.

A “knowledge graph” refers to a structured representation of relationships between various entities. The knowledge graph organizes information where nodes represent entities and edges represent relationships between entities. For example, a UoM knowledge graph captures relationships (nodes) for a UoM, such as (1) the quantitative measure (e.g., length, mass, time, speed, etc.); (2) the dimensions of the quantitative measure (e.g., for derived units where speed equals length/time, the dimensions are length and time); (3) the type of measurement system (e.g., SI, US, imperial, etc.); (4) the symbols defined by the measurement system (e.g., feet, ft or ′, etc.); (5) the commonly occurring representations in the context of ecommerce (e.g., centimeter, centimeter, etc.); and/or (6) the conversion factor for other measurement systems (e.g., foot to meter: 0.3048).

“Customer data” or “shopper data” (customers and shoppers are referred to interchangeably) refers to any data regarding a customer or customers. Customer data within a dataset may include, by way of example and not limitation, data that is sensed or determined from one or more sensors, such as location information of mobile device(s), smartphone data (such as phone state, charging data, date/time, or other information derived from a smartphone), activity information (for example: app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer.

“Business data” refers to any data regarding a business or businesses (a business may be referred to as merchandizer interchangeably). Business data within a dataset may include, by way of example and not limitation, data that is sensed or determined from one or more sensors, such as location information of a business(s) or where the business is conducting a transaction, ecommerce activity, data regarding products and/or product catalogs, data regarding business models (e.g., business-to-business (B2B), business-to-consumer (B2C), hybrid of B2B and B2C, etc.), data regarding industry verticals (e.g., manufacturing, clinical drugs, etc.), data regarding different geo-locations (e.g., United States, United Kingdom, etc.), historical search data from customers, historical purchase data from customers, and nearly any other source of data that may be used to provide information regarding the business.

An “inference model” refers to a computational model or algorithm that predicts based on input data. “Named entity recognition” (NER) refers to a natural language processing (NLP) technique that identifies and classifies named entities, such as locations, dates, quantities, etc. A “classifier” refers to a computational model or algorithm that assigns predefined categories or labels to input data based on features of the input data. An “autoencoder model” refers to a type of artificial neural network that is trained to learn efficient representations of input data. A “generative model” refers to a type of machine learning model that learns to generate new data based on training data, such as images, text, music, and other types of data.

### Overview of Exemplary Environments of Using Machine Learning to Optimize UoM Representations

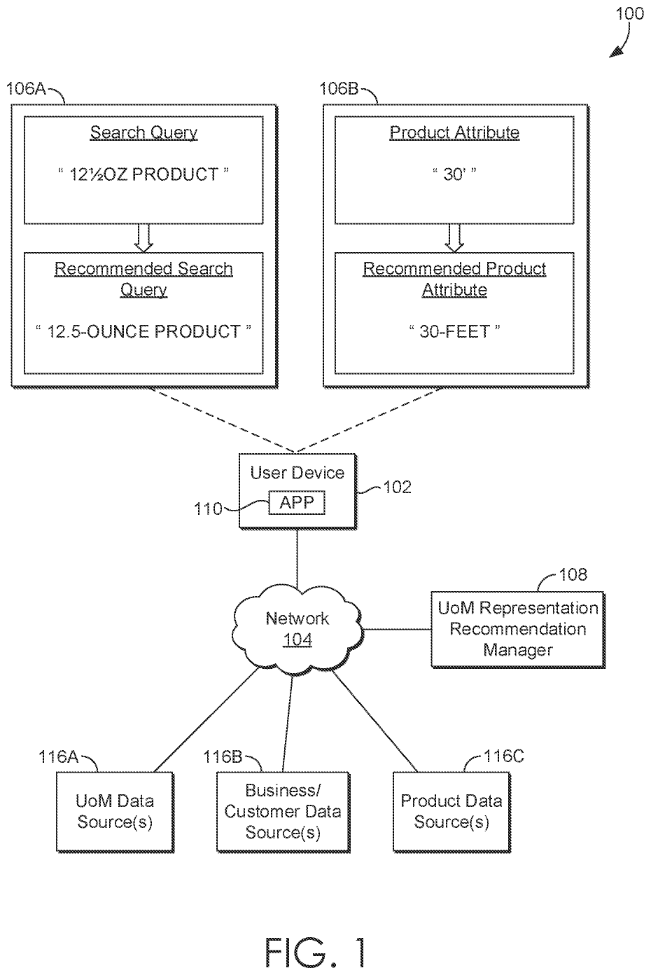

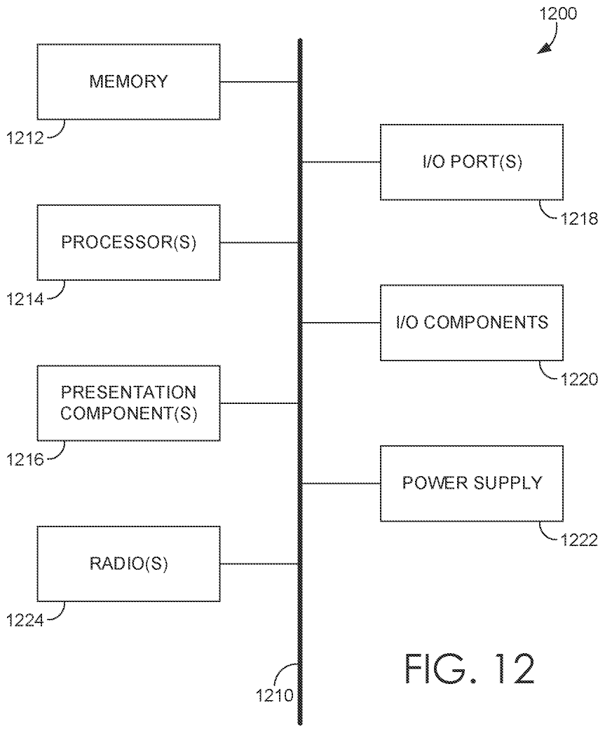

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 12.

It should be understood that operating environment 100 shown in FIG. 1 is an example of one suitable operating environment. Among other components not shown, operating environment 100 includes a user device 102, network 104, UoM data source(s) 116A, business and/or customer data source(s) 116B, product data source(s) 116C, UoM representation recommendation manager 108. Operating environment 100 also shows examples of using machine learning to optimize UoM representations by generating a recommended UoM representation in a search query in example 106A and generating a recommended UoM representation for a product attribute in example 106B. Each of the components shown in FIG. 1 can be implemented via any type of computing device, such as one or more of computing device 1200 described in connection to FIG. 12, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., a customer or a business). For example, in some implementations, such devices are the type of computing device described in relation to FIG. 12. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

User device 102 can be a client device on a client-side of operating environment 100, while UoM representation recommendation manager 108 can be on a server-side of operating environment 100. UoM representation recommendation manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or UoM representation recommendation manager 108 to remain as separate entities.

Application 110 operating on user device 102 can generally be any application capable of facilitating the exchange of information between the user device(s) and the UoM representation recommendation manager 108 in carrying out determining recommended UoM representations for UoM representations in product descriptions and/or search queries in order to optimize search queries and/or generating new attribute names and/or taxonomies based on UoM representations to optimize search queries and web page navigation. In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly. In embodiments, user interactions with application 110 can be monitored (e.g., via a server) to identify interactions of a user with products and/or search queries for products. For example, user interactions with application 110 can be monitored, including searching for products with particular UoM representations, selecting or clicking on a particular product, electronically purchasing a particular product, navigating to a particular website, and the like.

In accordance with embodiments herein, the application 110 can facilitate using machine learning to optimize UoM representations in an efficient and effective manner. In operation, a business can provide a product catalog through a user interface provided via the application 110. In some embodiments, the application 110 is a PIM system. As shown in the example of 106B, the product attribute of a product is “30” in the product catalog as provided. The UoM representation recommendation manager 108 can facilitate using machine learning to optimize UoM representations by utilizing a knowledge graph that stores relationships of various UoMs, a UoM inference model trained to extract and classify the UoM representation, and an autoencoder model trained provide a recommended product attribute based on contextual data learned from data sources 106A-C. As shown in the example 106B, UoM representation recommendation manager 108 provides the recommended product attribute of “30-Feet” through a user interface provided via the application 110. The recommendation provided by UoM representation recommendation manager 108 can be displayed via a display screen of the user device 102 and may be presented in any manner. As can be understood, the UoM representation for foot is recommended to be changed from “′” to “Feet” based on contextual data learned by UoM representation recommendation manager 108. In some embodiments, the recommended UoM representation can be provided in the PIM system. The business user can then choose to accept or rejected the recommendation provided by UoM representation recommendation manager 108 through the user interface provided via the application 110.

Additionally, or alternatively, in operation, a customer can search for products (e.g., perform a search for products to purchase on an e-commerce website) via a user interface provided via the application 110. As shown in the example 106A, the customer enters a search query for “12½ OZ PRODUCT” through a user interface provided via the application 110. The UoM representation recommendation manager 108 can facilitate using machine learning to optimize UoM representations by utilizing a knowledge graph that stores relationships of various UoMs, a UoM inference model trained to extract and classify the UoM representation, and an autoencoder model trained provide a recommended product attribute based on contextual data learned from data sources 106A-C. As shown in the example 106A, UoM representation recommendation manager 108 provides the recommended search query of “12.5-OUNCE PRODUCT” through a user interface provided via the application 110. The recommendation provided by UoM representation recommendation manager 108 can be displayed via a display screen of the user device 102 and may be presented in any manner. As can be understood, the UoM representation for ounce is recommended to be changed from “OZ” to “ounce” and the number is recommend to be changed from “121/2” to “12.5” based on contextual data learned by UoM representation recommendation manager 108. The customer performing the search query can then choose to accept or rejected the recommendation provided by UoM representation recommendation manager 108 through the user interface provided via the application 110.

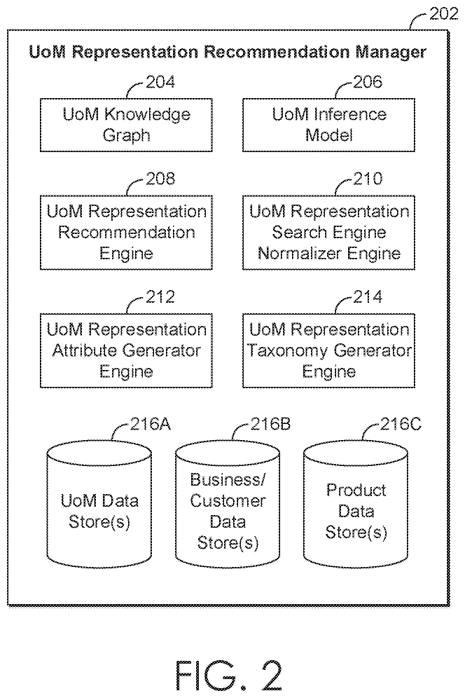

Additional embodiments of UoM representation recommendation manager 108 is described in further detail with respect to UoM representation recommendation manager 202 of FIG. 2, diagram 300 of FIG. 3, diagram 400 of FIG. 4, UoM representation recommender system 506 of FIG. 5, and UoM representation recommender system 606A-C and 616C of FIGS. 6A-C, diagram 700 of FIG. 7, and diagram 800 of FIG. 8.

The UoM representation recommendation manager 108 can obtain user data from user device 102 (e.g., the customer's customer data or business data from the business), UoM data (e.g., data regarding UoM representations from measurement systems, such as from Wikipedia® or any other source of data) from UoM data source(s) 116A, business data and/or customer data from business and/or customer data source(s) 116B, and product data (e.g., product descriptions with corresponding product attributes, etc.) from product data source(s) 116C. Data sources 116A-116C may be any type of source providing data (e.g., UoM data, business data, customer data, product data, etc.). Generally, the UoM representation recommendation manager 108 receives data from any number of devices. As such, the UoM representation recommendation manager 108 can identify and/or collect data from various user devices, such as user device 102, and sources, such as data sources 116A-116C. In this regard, the UoM representation recommendation manager 108 can retrieve or receive data collected or identified at various components, or sensors associated therewith.

As described, in some cases, the UoM representation recommendation manager 108 can retrieve or receive UoM data from the user device 102 and UoM data source(s) 116A. Further, as described, UoM representation recommendation manager 108 may generate UoM data for storage. As described, in some cases, the UoM representation recommendation manager 108 can retrieve or receive business data and/or customer data from the user device 102 and business and/or customer data source(s) 116B. Additionally or alternatively, the UoM representation recommendation manager 108 can retrieve or receive product data from product data source(s) 106C. By way of example and not limitation, product data within a dataset may include data that is sensed or determined from one or more sensors, such as product images, product names, product prices, product descriptions, product titles, and nearly any other source of data that may be used to identify the product or information about the product, as described herein.

Such UoM data, business data, customer data, and product data can be initially collected at remote locations or systems and transmitted to a data store for access by UoM representation recommendation manager 108. In accordance with embodiments described herein, UoM data, business data, customer data, and product data collection may occur at data sources 106A-C, respectively. In some cases, data sources 106A-C, or portion thereof, may be client devices, that is, computing devices operated by existing UoM data sources (e.g., Wikipedia®) businesses (e.g., product listings or catalogs, business verticals, etc.) or customers (e.g., online product searchers or viewers, online product customers, etc.), respectively, for example. As such, client devices, or components associated therewith, can be used to collect various types of UoM data, business data, customer data, and product data. For example, in some embodiments, customer data may be obtained and collected at a client device operated by a customer via one or more sensors, which may be on or associated with one or more client devices and/or other computing devices. As another example, in some embodiments, product data may be obtained and collected at an e-commerce website via one or more sensors. As used herein, a sensor may include a function, routine, component, or combination thereof for sensing, detecting, or otherwise obtaining information, such as customer and product data, and may be embodied as hardware, software, or both.

In addition or in the alternative to data sources 106A-C including client devices, data sources 106C may include servers, data stores, or other components that collect UoM data, business data, customer data, and product data, for example, from client devices associated with customers or e-commerce websites. For example, in interacting with a client device, datasets may be captured at data sources 106A-C and, thereafter, such customer data can be provided to UoM representation recommendation manager 108 for storage. As another example, in interacting with an e-commerce website, datasets may be captured at data sources 106A-C and, thereafter, such UoM data, business data, customer data, and product data can be provided to UoM representation recommendation manager 108 for storage. UoM data, business data, customer data, and product data may additionally or alternatively be obtained from an external server, for example, that collects UoM data, business data, customer data, and product data. UoM data, business data, customer data, and product data can be obtained at a data source periodically or in an ongoing manner (or at any time) and provided to the UoM representation recommendation manager 108 to facilitate using machine learning to optimize UoM representations. UoM data, business data, customer data, and product data can be manually input into the UoM representation recommendation manager 108. For example, UoM data or product catalogs may be manually input into the UoM representation recommendation manager 108 in order to train various machine learning model operating at the UoM representation recommendation manager 108 (e.g., UoM inference model 304 and UoM representation recommender 306 of FIG. 3, UoM representation recommender system 406 of FIG. 4, UoM representation recommender system 506 of FIG. 5, UoM representation recommender 606A-C and 616C of FIGS. 6A-C, UoM inference model 706 and generative model 710 of FIG. 7, UoM inference model 806 and generative model 810 of FIG. 8, etc.).

UoM representation recommendation manager 108 can be or include a server, including one or more processors, and one or more computer-readable media. The computer-readable media includes computer-readable instructions executable by the one or more processors. The instructions can optionally implement one or more components of UoM representation recommendation manager 108, described in additional detail below with respect to UoM representation recommendation manager 202 of FIG. 2.

For cloud-based implementations, the instructions on UoM representation recommendation manager 108 can implement one or more components, and application 110 can be utilized by a user to interface with the functionality implemented on UoM representation recommendation manager 108. In some cases, application 110 comprises a web browser. In other cases, UoM representation recommendation manager 108 may not be required. For example, the components of UoM representation recommendation manager 108 may be implemented completely on a user device, such as user device 102. In this case, UoM representation recommendation manager 108 may be embodied at least partially by the instructions corresponding to application 110.

Thus, it should be appreciated that UoM representation recommendation manager 108 may be provided via multiple devices arranged in a distributed environment that collectively provide the functionality described herein. Additionally, other components not shown may also be included within the distributed environment. In addition, or instead, UoM representation recommendation manager 108 can be integrated, at least partially, into a user device, such as user device 102. Furthermore, UoM representation recommendation manager 108 may at least partially be embodied as a cloud computing service.

Referring to FIG. 2, aspects of an illustrative UoM representation recommendation management system are shown, in accordance with various embodiments of the present disclosure. At a high level, embodiments described herein using machine learning to optimize UoM representations by determining optimal UoM representations for product attributes in product descriptions and/or search queries based on context, such as the business model, industry vertical, geo-location of the market, product catalog data, shopper behavior data, etc.

As shown in FIG. 2, UoM representation recommendation manager 202 includes a UoM knowledge graph 204, a UoM inference model 206, a UoM representation recommender module 208, a UoM representation search engine normalizer engine 210, a UoM representation attribute generator engine 212, a UoM representation taxonomy generator engine 214, a UoM data store 216A, a business and/or customer data store 216B, and a product data store 216C. The foregoing components of UoM representation recommendation manager 202 can be implemented, for example, in operating environment 100 of FIG. 1. In particular, those components may be integrated into any suitable combination of user devices 102 and/or UoM representation recommendation manager 108.

UoM data store 216A, business and/or customer data store 216B, and product data store 216C can store computer instructions (e.g., software program instructions, routines, or services), data, and/or models used in embodiments described herein. In some implementations, UoM data store 216A, business and/or customer data store 216B, and product data store 216C stores information or data received or generated via the various components of UoM representation recommendation manager 202 and provides the various components with access to that information or data, as needed. Although depicted as three components, UoM data store 216A, business and/or customer data store 216B, and product data store 216C may be embodied as one or more data stores or each as one or more data stores. Further, the information in UoM data store 216A, business and/or customer data store 216B, and product data store 216C may be distributed in any suitable manner across one or more data stores for storage (which may be hosted externally).

In embodiments, data stored in UoM data store 216A includes data regarding relationships regarding various UoMs. For example, UoM data store 216A can store data regarding relationships regarding various UoMs from various sources, such as Wikipedia® or any other source of data. In some cases, UoM representation recommendation manager 202, or components associated therewith, can obtain data regarding relationships regarding various UoMs from client devices (e.g., a user device(s)). In other cases, data regarding relationships regarding various UoMs can be received from one or more data stores in the cloud, or data generated by the UoM representation recommendation manager 202.

In embodiments, data stored in business and/or customer data store 216B includes data regarding the business and/or customers. For example, business and/or customer data store 216B can stored data such as product catalogs from different business models; product catalogs from different industry verticals; product catalogs from different geo-locations; customer data, such as historical customer search query data; customer data from various sources, such as social platforms, e-commerce platforms, location data for a customer's device, or any data source that provides data about the customer, etc. In some cases, UoM representation recommendation manager 202, or components associated therewith, can obtain business and/or customer data from client devices (e.g., a user device(s)). In other cases, business and/or customer data can be received from one or more data stores in the cloud, or data generated by the UoM representation recommendation manager 202.

In embodiments, data stored in product data store 216C includes a product catalog(s), product images, names, prices, descriptions, attributes and/or the like. For example, product data store 216 can store product descriptions with product attributes for a catalog of products in a PIM system. In some cases, UoM representation recommendation manager 202, or components associated therewith, can obtain product data from client devices (e.g., a user device(s)). In other cases, product data can be received from one or more data stores in the cloud, or data generated by the UoM representation recommendation manager 202.

The UoM knowledge graph 204 is generally configured to store relationships for various UoMs and is enriched from UoM data store 216A. The UoM knowledge graph 204 can include rules, conditions, associations, models, algorithms, or the like to store relationships for various UoMs. Embodiments of UoM knowledge graph 204 are described in further detail in relation to UoM knowledge graph 302 of FIG. 3.

The UoM inference model 206 is generally configured to extract and classify UoM representations in product descriptions from product data store 216C and/or search queries. The UoM inference model 206 can include rules, conditions, associations, models, algorithms, or the like to extract and classify UoM representations. For example, UoM inference model 206 may comprise NLP techniques, statistical model, fuzzy logic, neural network, finite state machine, support vector machine, logistic regression, clustering, or machine-learning techniques, similar statistical classification processes, or combinations of these to extract and classify UoM representations.

In some embodiments, UoM inference model 206 uses NER methods to detect (e.g., extract) UoM representations (or missing UoM representations) in text. In some embodiments, UoM inference model 304 includes a pre-trained classifier for contextual disambiguation of UoM representations. For example, the pre-trained classifier learns UoM representations from data sources (e.g., 216A-C, knowledge graph 204, Wikipedia®, glove vector representations of UoMs, product catalog data, or any other source of data) in order to disambiguate between similar looking UoM representations based on the context in which they appear. Embodiments of UoM inference model 206 are described in further detail in relation to UoM inference model 304 of FIG. 3, UM inference model 706 of FIG. 7, and UoM inference model 806 of FIG. 8.

The UoM representation recommender engine 208 is generally configured to recommend the optimal UoM representation based on the UoM representations extracted by UoM inference model 206. The UoM representation recommender engine 208 can include rules, conditions, associations, models, algorithms, or the like to provide recommend the optimal UoM representation. For example, UoM representation recommender engine 208 may comprise NLP techniques, statistical model, fuzzy logic, neural network, finite state machine, support vector machine, logistic regression, clustering, or machine-learning techniques, similar statistical classification processes, or combinations of these to provide recommend the optimal UoM representation.

In some embodiments, the UoM representation recommender engine 208 includes an autoencoder that learns (e.g., is trained based on) UoM representations from various data in UoM knowledge graph 204 or UoM data store 216A, business and/or customer data store 216B, and/or product data store 216C. In this regard, the UoM representation recommender engine 208 is trained to recommend UoM representations based on context, such as the business model, industry vertical, geo-location of the market, product catalog data, shopper behavior data, etc. Embodiments of UoM representation recommender engine 208 are described in further detail in relation to UoM representation recommender 306 of FIG. 3, UoM representation recommender system 406 of FIG. 4, UoM representation recommender system 506 of FIG. 5, and UoM representation recommender system 606A-C and 616C of FIGS. 6A-C.

The UoM representation search engine normalizer engine 210 is generally configured to normalize UoM representations presented in a search query and normalize UoM representations of product attributes in a product catalog for indexation in order to optimize search and ranking in search engines (e.g., an ecommerce search engine, a search engine of a product catalog, etc.). The UoM representation search engine normalizer engine 210 can include rules, conditions, associations, models, algorithms, or the like to normalize UoM representations in search queries and product attributes of a product catalog. For example, UoM representation search engine normalizer engine 210 may comprise NLP techniques, statistical model, fuzzy logic, neural network, finite state machine, support vector machine, logistic regression, clustering, or machine-learning techniques, similar statistical classification processes, or combinations of these to normalize UoM representations in search queries and product attributes of a product catalog.

In embodiments, UoM representation search engine normalizer engine 210 normalizes UoM representations of the search query to match the normalized UoM representations of the product attributes of the products being searched resulting in optimized search query results. Embodiments of UoM representation search engine normalizer engine 210 are described in further detail in relation to diagrams 600A-C of FIGS. 6A-C.

The UoM representation attribute generator engine 212 is generally configured to generate new attribute names for a product based on UoM representations of the product to improve the discoverability of the product in search engines. The UoM representation attribute generator engine 212 can include rules, conditions, associations, models, algorithms, or the like to generate new attribute names for a product based on UoM representations of the product. For example, UoM representation attribute generator engine 212 may comprise NLP techniques, statistical model, fuzzy logic, neural network, finite state machine, support vector machine, logistic regression, clustering, or machine-learning techniques, similar statistical classification processes, or combinations of these to generate new attribute names for a product based on UoM representations of the product.

In embodiments, UoM representation attribute generator engine 212, through a UoM inference model (e.g., UoM inference model 206 of FIG. 2, UoM inference model 304 of FIG. 3, UoM inference model 706 of FIG. 7, UoM inference model 806 of FIG. 8, etc.), scans unstructured product details of a product description in catalogs of a product to identify name-value pairs of UoM representations with respect to product attributes. UoM representation attribute generator engine 212, through a generative model (e.g., generative model 710 of FIG. 7, generative model 810 of FIG. 8, etc.), generates new attribute names for the name-value pairs utilizing UoM name value pairs, the context from the product catalog, search query history, etc. in order to improve the discoverability of the product in search engines. Embodiments of UoM representation attribute generator engine 212 are described in further detail in relation to diagram 700 of FIG. 7.

The UoM representation taxonomy generator engine 214 is generally configured to generate new or improved taxonomies (e.g., categories) for products in a product catalog based on UoM representations of the products to improve the discoverability of the product in search queries and/or web navigation to find a product. The UoM representation taxonomy generator engine 214 can include rules, conditions, associations, models, algorithms, or the like to new or improved taxonomies (e.g., categories) for products in a product catalog based on UoM representations of the products. For example, UoM representation taxonomy generator engine 214 may comprise NLP techniques, statistical model, fuzzy logic, neural network, finite state machine, support vector machine, logistic regression, clustering, or machine-learning techniques, similar statistical classification processes, or combinations of these to new or improved taxonomies (e.g., categories) for products in a product catalog based on UoM representations of the products.

In embodiments, UoM representation taxonomy generator engine 214, through a UoM inference model (e.g., UoM inference model 206 of FIG. 2, UoM inference model 304 of FIG. 3, UoM inference model 706 of FIG. 7, UoM inference model 806 of FIG. 8, etc.), scans product descriptions in product catalogs to identify name-value pairs of UoM representations with respect to product attributes. UoM representation taxonomy generator engine 214, through a generative model (e.g., generative model 710 of FIG. 7, generative model 810 of FIG. 8, etc.), generates new or improved taxonomies based on the UoM name value pairs, the context from the product catalog, search query history, etc. in order to improve the discoverability of the product in search queries and/or web page navigation to find a product. Embodiments of UoM representation taxonomy generator engine 214 are described in further detail in relation to diagram 800 of FIG. 8.

FIG. 3 provides an example diagram of an example UoM representation recommender system, in accordance with embodiments described herein. As described herein, such UoM representation recommender system can be used to optimize UoM representations for product search queries. Diagram 300 is an example diagram for an example UoM representation recommender system and includes example data sources 310 to train the UoM representation recommender system. As shown, the UoM representation recommender system of diagram 300 includes a UoM knowledge graph 302 that integrates UoM representations from measurement systems. For example, UoM knowledge graph 302 can include UoM representation from SI, US, imperial, and any other measurement system. In some embodiments, the UoM knowledge graph 302 is a subgraph within a commerce knowledge graph that integrates product data with real-world UoM knowledge domain as captured by the UoM sub-graph. In some examples, the UoM knowledge graph 302 is enriched through a source of data 310A regarding UoM representations from measurement systems (e.g., Wikipedia® or any other source of data).

As shown the UoM representation recommender system of diagram 300 can include relationships for each UoM representation stored in the UoM knowledge graph 302. For example, UoM knowledge graph 302 captures relationships (nodes) for a UoM representation, such as (1) the quantitative measure (e.g., length, mass, time, speed, etc.) referred to as “has_entity” in 302; (2) the dimensions of the quantitative measure (e.g., for derived units where speed equals length/time, the dimensions are length and time) referred to as “has_dimensions” in 302; (3) the type of measurement system (e.g., SI, US, imperial, etc.) referred to as “is_type” in 302; (4) the symbols defined by the measurement system (e.g., feet, ft or′, etc.) referred to as “has_symbols” in 302; (5) the commonly occurring representations in the context of ecommerce (e.g., centimeter, centimeter, etc.) referred to as “has_surfaces” in 302; and/or (6) the conversion factor for other measurement systems (e.g., foot to meter: 0.3048) referred to as “is_equivalent_of” in 302.

Further, as shown, the UoM representation recommender system of diagram 300 includes a UoM inference model 304 that extracts and classifies UoM representations. In some embodiments, UoM inference model 304 includes a UoM named entity extractor 304A that leverages detects (e.g., extracts) UoM representations (or missing UoM representations) in text using NER methods. In some embodiments, UoM inference model 304 includes a pre-trained classifier 304B for contextual disambiguation of UoM representation. For example, pre-trained classifier 304B learns UoM representations from data sources 310B (e.g., knowledge graph 302, Wikipedia®, glove vector representations of UoMs, product catalog data, or any other source of data) in order to disambiguate between similar looking UoM representations based on the context in which they appear. For example, in the context of a coffee table, the model infers that “30″” is “30 inches,” even though “″” is both a symbol for “inches” and “seconds of arc” based on the context that “″” is referring to a coffee table. In some embodiments, classifier 304B can disambiguate and infer erroneously represented UoM representations in catalogs based on the context, such as the industry vertical, catalog context, etc. For example, classifier 304B interprets erroneous representations such as “G” or “GMS” or “GS” as the symbol for the unit “gram” based on the context of the UoM representation. In some embodiments, classifier 304B learns industry-specific UoM representations of derived UoM representation and enriches the UoM knowledge graph. For example, classifier 304B can learn that “ct.wt.” is a derived unit for “Carat Weight” that represents diamond weight in jewelry catalogs and enriches the knowledge graph by adding “ct. wt.” as an additional commonly occurring representation in the context of ecommerce.

Further, as shown, the UoM representation recommender system of diagram 300 includes a UoM representation recommender 306 that recommends UoM representations (e.g., to provide the optimal UoM representation for a product in a product description, search query, etc.). In some embodiments, the UoM representation recommender 306 includes an autoencoder 306A that learns (e.g., is trained based on) UoM representations from various data sources 310C, such as product catalogs from different business models (e.g., B2B, B2C, Hybrid of B2B and B2C, etc.); product catalogs from different industry verticals (e.g., manufacturing, clinical drugs, etc.); product catalogs from different geo-locations (e.g., US, UK, etc.); UoM knowledge graph 302; customer data, such as historical customer search query data (e.g., customers search for “10 ounce” instead of “10 oz”), etc. In this regard, the UoM representation recommender 306, through autoencoder 306A, is trained to recommend UoM representations based on context, such as the business model, industry vertical, geo-location of the market, product catalog data, shopper behavior data, etc.

In this regard, in the example shown in FIG. 3, UoM representation recommender 306 provides output 306 that includes quant.value 308A, quant.unit.name 308B, and quant.unit.entity 308C. For example, for a product that includes a measurement of 10 foot height, quant.value 308A would correspond to the value “10,” quant.unit.name 308B would correspond to the UoM representation of “foot,” and quant.unit.entity 308C corresponds to the quantitative measure of “length.”

In some embodiments, the UoM representation recommender 306, through autoencoder 306A, is trained to recommend UoM representations for a product attribute (e.g., weight of a diamond in carat weight, height of a tent in feet, etc.) to the merchandizer based on context to localize a product catalog for a specific geo-location and/or target a certain shopper segment (e.g., a B2C customer may be looking for a smaller size product as opposed to a business customer in a B2B scenario, etc.). In some embodiments, UoM representation recommender 306 includes a unit converter 306B in order to convert the UoM representation in the product description or catalog of one measurement system into the recommended UoM representation of a different measurement system. For example, UoM representation recommender 306 may recommend “908 grams” as UoM representation for a product attribute of weight listed as “2 lb” in order to localize the product catalog for United Kingdom (UK) markets. In embodiments, the unit converter 306B utilizes the relationships between measurement systems stored in knowledge graph 302.

Further, in some embodiments, UoM representation recommender 306 generates UoM representation suggestions for search queries of shoppers in order to nudge the shopper to modify their search query to optimize the results of the search query. For example, UoM representation recommender 306 generates UoM representation suggestions for search queries of shoppers to match the UoM representation of a product catalog being searched to provide optimized search results from the product catalog. For example, UoM representation recommender 306 may generate a suggestion to the shopper “do you mean “12.5-ounce brake fluid?” for a shopper's search query “12½ oz brake fluid” that provides little to no search results.

FIG. 4 provides an example diagram of an example generating UoM representation suggestions for a product catalog, in accordance with embodiments described herein. As described herein, such normalizing of UoM representations of a product catalog can be used to optimize UoM representations for product search queries of the product catalog. Diagram 400 is an example diagram of an example normalizing UoM representations of a product catalog. As shown, a merchandizer 402 inputs a product catalog 404 in a UoM representation recommender system 406 (e.g., UoM representation recommender system 302 of FIG. 3). Further, in some embodiments, contextual data 402A providing the context for the product catalog of the business can be input into the UoM representation recommender system 406. For example, contextual data 402A can include data regarding the business vertical, industry, geo-location, shopper behavior, etc. In this regard, the UoM representation recommender system 406 can provide recommendations to the merchandizer 402 to normalize UoM representations of a product catalog based on the product catalog and/or any amount of contextual data regarding the product catalog. In some embodiments, the UoM representation recommender system 406 provides recommendations to the merchandizer 402 to normalize UoM representation of a product catalog through a PIM system. In some embodiments, the UoM representation recommender system 406 provides recommendations UoM representations of product attributes of a product when there are little to no search results with the product in response to search queries from customers.

In some embodiments, the UoM representation recommender system 406 can perform missing UoM representation imputation 408. For example, a product catalog may include a product weight list as “5” without any UoM representations, such as whether “5” refers to “5 lbs,” “5 kg,” or a different UoM representation. In this example, the UoM representation recommender system 406 can perform missing UoM representation imputation 408 to provide recommendations for the product attributes with missing UoM representations based on context, such as the geo-location, industry, business vertical, shopper search query history, etc. The UoM representation recommender system 406 provides recommendations to the merchandizer 402 to automatically or manually fill in missing UoM representations for product attributes in the product catalog (e.g., through a PIM system).

In some embodiments, the UoM representation recommender system 406 can perform UoM representation correction 410. In some embodiments, a UoM representation may be erroneous for a product attribute of a product in the product catalog. For example, length of a cord may erroneously list the length in meters instead of feet. In this regard, the UoM representation recommender system 406 can perform UoM representation correction 410 to provide recommendations for the product attributes with erroneous UoM representations based on context, such as the geo-location, industry, business vertical, shopper search query history, etc. The UoM representation recommender system 406 provides recommendations to the merchandizer 402 to automatically or manually correct erroneous UoM representations for product attributes in the product catalog (e.g., through a PIM system).

In some embodiments, a UoM representation for a product attribute of a product may be inconsistent between different products of a product catalog. For example, length may be represented as both “30” and “30-Feet” for similar products in the same catalog. In this regard, the UoM representation recommender system 406 can perform UoM representation correction 410 to provide recommendations for the product attributes with inconsistent UoM representations in a product catalog based on context, such as the geo-location, industry, business vertical, shopper search query history, etc. The UoM representation recommender system 406 provides recommendations to the merchandizer 402 to automatically or manually correct inconsistent UoM representations for product attributes in the product catalog (e.g., through a PIM system).

In some embodiments, a UoM representation for a product attribute of a product in a product catalog may be inconsistent with respect to industry standards, shopper search queries, etc. For example, the industry standard may be to list length in terms of inches as opposed to feet. As another example, shoppers may search for “microlitre” whereas the UoM representation listed for the product is “μL.” In this regard, the UoM representation recommender system 406 can perform UoM representation correction 410 to provide recommendations for the product attributes with inconsistencies with respect to industry standards, shopper search queries, etc. based on context, such as the geo-location, industry, business vertical, shopper search query history, etc. The UoM representation recommender system 406 provides recommendations to the merchandizer 402 to automatically or manually correct inconsistent UoM representations for product attributes in the product catalog (e.g., through a PIM system).

In some embodiments, the UoM representation recommender system 406 can perform UoM representation localization 412. For example, UoM representation recommender system 406 can perform UoM representation localization 412 to recommend “908 grams” as UoM representation for a product attribute of weight listed as “2 lb” in order to localize the product catalog for UK markets. In this regard, UoM representation recommender system 406 performs UoM representation localization 412 to provide recommendations for the product attributes based on context, such as the geo-location, to enable shoppers to view UoM representations in their preferred measurement system. The UoM representation recommender system 406 provides recommendations to the merchandizer 402 to automatically or manually localize UoM representations for product attributes in the product catalog (e.g., through a PIM system).

In this regard, UoM representation recommender system 406 can perform missing UoM representation imputation 408, UoM representation correction 410, and/or UoM representation localization 412 and present recommendations to the merchandizer 402. For example, UoM representation recommender system 406 can present recommendations through a PIM system of the business (e.g., merchandizer 402).

FIG. 5 provides an example diagram of an example generating UoM representation suggestions for shopper search queries, in accordance with embodiments described herein. As described herein, such generating UoM representation suggestions for shopper search queries can be used to optimize the search queries. Diagram 500 is an example diagram of an example generating UoM representation suggestions for shopper search queries. As shown, a shopper 502 inputs a search query 504 into a search engine (e.g., a search engine for a product catalog for a website of a business or any search engine). The search query 504 is then received by a UoM representation recommender system 506 (e.g., UoM representation recommender system 302 of FIG. 3.). Further, in some embodiments, data 502A of the business and/or the shopper can be input into the UoM representation recommender system 506. For example, data 502A providing the context for the product catalog and/or shopper inputting the search query can be input into the UoM representation recommender system 506. For example, data regarding the business vertical, industry, geo-location, shopper behavior data, etc. can be input into the UoM representation recommender system 506.

The UoM representation recommender system 506 can generate UoM representation suggestions 508 for the search query 504, which the shopper 502 can use to perform an updated search query 510. For example, for a search query with UoM representation of “microliter,” UoM representation recommender system 506 may generate UoM representation suggestions 508 to change “microlitre” to “μL” based on context, such as the product in the search query, product catalog, geo-location, industry, business vertical, shopper search query history, etc. In this regard, UoM representation recommender system 506 provides recommendations for the UoM representations in the search query 504 of the shopper 502 to optimize the search results by improving ranking and relevance of search results.

FIG. 6A provides an example diagram of an example normalizing UoM representations for search queries, in accordance with embodiments described herein. FIG. 6B provides an example diagram of an example normalizing UoM representations for product attributes, in accordance with embodiments described herein. FIG. 6C provides an example diagram of an example normalizing UoM representations in a search engine, in accordance with embodiments described herein. As described herein, such normalizing of UoM representations in search queries, product attributes, and the search engine can be used to optimize search queries.

Generally, and at a high level, FIGS. 6A-6C provide UoM representation normalization for UoM representations presented in a search query and UoM representation normalization for product attributes in a product catalog for indexation in order to optimize search and ranking in search engines (e.g., an ecommerce search engine, a search engine of a product catalog, etc.). In this regard, the normalized UoM representations of the search query will match the normalized UoM representations of the product attributes of the products being searched resulting in optimized search query results.

With respect to FIG. 6A, diagram 600A is an example diagram of an example normalizing UoM representations for search queries. As shown, a search query 602A is received by a UoM representation recommender 606A (e.g., UoM representation recommender system 302 of FIG. 3, UoM representation recommender 306, etc.). Further, in some embodiments, data 604A of the business and/or the shopper can be input into the UoM representation recommender 606A. For example, data 604A providing the context for the product catalog and/or shopper inputting the search query can be input into the UoM representation recommender 606A. For example, data regarding the business vertical, industry, geo-location, shopper behavior data, etc. can be input into the UoM representation recommender 606A. The UoM representation recommender 606A generates normalized UoM representations for the search query 602A (e.g., in order to perform a query during query time 602C of FIG. 6C). In the example provided in FIG. 6A, UoM representation recommender 606A provides normalized output that includes quant.value 608A, quant.unit.name 610A, and quant.unit.entity 612A. For example, for a search query 602A for a “10 ft high tent,” the UoM representation recommender provides output of a quant.value 608A corresponds to the value “10,” quant.unit.name 610A corresponds to the representation of the UoM of “foot,” and quant.unit.entity 612C corresponds to the entity (e.g., quantitative measure) of “length.”

With respect to FIG. 6B, diagram 600B is an example diagram of an example normalizing UoM representations for product attributes. As shown, product attribute 602B of a product in a product catalog is received by a UoM representation recommender 606B (e.g., UoM representation recommender system 302 of FIG. 3, UoM representation recommender 306, etc.). Further, in some embodiments, data 604B of the business can be input into the UoM representation recommender 606B. For example, data 604B providing the context for the product catalog can be input into the UoM representation recommender 606B. For example, data regarding the business vertical, industry, geo-location, shopper behavior data, etc. can be input into the UoM representation recommender 606B. The UoM representation recommender 606B generates normalized UoM representations for the product attribute 602A of a product of a product catalog (e.g., in order to perform a query for the indexed product attributes of a product of FIG. 6C). In the example shown in FIG. 6B, UoM representation recommender 606B provides output that includes quant.value 608B, quant.unit.name 610B, and quant.unit.entity 612B. For example, for a product attribute 602B for a “overall_tent_height: 10,” the UoM representation recommender provides output of a quant.value 608B corresponds to the value “10,” quant.unit.name 610B corresponds to the representation of the UoM of “foot,” and quant.unit.entity 612B corresponds to the entity (e.g., quantitative measure) of “length.”

As can be understood from the examples of FIGS. 6A and 6B, although the search query 602A was originally “10 ft high tent” and the product attribute 602B of the product was originally in the product catalog as “overall_tent_height: 10,” UoM representation recommender (606A/B) normalizes the UoM representations of the search query 602A and product attribute 602B to match in order to optimize the search query.

With respect to FIG. 6C, diagram 600C is an example diagram of an example normalizing UoM representations in a search engine. As shown, during query time 602C, a search query 604C is received by UoM normalizer 606C (e.g., as discussed with respect to UoM representation recommender 606A of FIG. 6A) in order to normalize the UoM representations in the search query 604C. The normalized UoM representations of the search query 604C as output by the UoM normalizer 606C are utilized in an expanded query 608C of index 610C (e.g., elastic search (ES) indices or any type of index, database, etc. utilized by a search engine to search for products). In some embodiments, UoM normalizer 606C can be leveraged in query suggestion workflows to infer UoMs in search queries and to suggest alternate representations that match catalog side representation to the shopper to enable them to modify their search query in case of zero results. For example, UoM normalizer can generate synonym lists for units to generated recommendations for search queries to improving ranking and relevance of search results (e.g., suggesting synonym pairs to customer performing search query, for example, “GS” may be recommended as “gm”, “microlitre” may be recommended as “μL”).

During index time 612C, a product catalog is received by UoM normalizer 616C (e.g., as discussed with respect to UoM representation recommender 606B of FIG. 6B) in order to normalize the UoM representations in the product catalog 614C. The normalized UoM representations of the product catalog 614C as output by the UoM normalizer 616C are stored in the index 610C. In some embodiments, the normalized UoM representations of the product attributes output by UoM normalizer 616C can be specified in the index definition, on a per-attribute basis for the product, and/or for text attributes so that the normalized UoM representations are filterable, facet-able and/or searchable in the search engine through index 610C.

In this regard, the normalized UoM representations for the product attributes of products of the expanded query 608C will match the normalized UoM representations for the product attributes of products of the product catalog, thereby increasing the likelihood that the UoM representations of the search query will match the UoM representations of the product catalog.

FIG. 7 provides an example diagram of an example generating UoM representation attributes from a product description, in accordance with embodiments described herein. As described herein, such generating UoM representation attributes from a product description of a product can be used to optimize the search query results with the product. Diagram 700 is an example diagram of an example generating UoM representation suggestions for shopper search queries. Generally, and at a high level, new attribute information can be added to as attributes for a product in a search engine index of a product catalog to improve the discoverability of the product in search engines. In this regard, unstructured product details of a product description in catalogs can be scanned by a UoM attribute generator in order to generate new attribute name-value pairs for products with the corresponding UoM representation. For example, an inferred name-value pair corresponding to the “45″ circumference” of a product may be identified. A generative model utilizing the name value-pair, context from the product catalog, and search queries from customers may generate a new attribute name for the name-value pair of “45″ around.” The new attribute name-value pairs are presented as recommendations to the merchandizer in order to incorporate the new attribute name-value pairs into the product catalog and/or search engine index.

As shown, the product description(s) 702 for a product(s) is input into a UoM inference model 706 (e.g., UoM inference model 304 of FIG. 3). In some embodiments, the product is identified as having zero results in search queries by customers in block 704. As can be understood, the merchandizer may want to identify different attributes of the product in order to improve the discoverability of the product in search engines due to the lack of search results with the product.

UoM inference model 706 outputs inferred UoM name-values pairs in block 708. For example, an inferred name-value pair corresponding to the “45″ circumference” of a product may be identified by UoM inference model 706. The inferred UoM name-value pairs are then input into a generative model 710 to generate new attribute names for UoM attribute name-value pairs 712. The generative model 710 utilizes the UoM name value pairs, the context from the product catalog, and/or the UoM representations in zero result queries analyzed for the product along with the query context in order to generate the new attribute names. For example, the generative model 710 utilizing the name value-pair of “45″ circumference,” context from the product catalog, and search queries from customers may generate a new attribute name for the name-value pair of “45″ around” as the customers searched for the term “around” instead of “circumference.” In block 714, the UoM attribute name-value pairs with the new attribute names are served as attribute recommendations to merchandizers 716. The merchandizers 716 can then approve the recommended attributes to enrich the existing product attributes of the product with the new UoM attributes in block 718. In block 720, merchandizers can incorporate the new attributes into the product catalog and set the new attributes as searchable, filterable, and/or facet-able in the search engine index to improve search and ranking for the product.

FIG. 8 provides an example diagram of an example generating taxonomies from UoM representations from product descriptions in a product catalog, in accordance with embodiments described herein. As described herein, such generating taxonomies from UoM representations from product descriptions in a product catalog can be used to optimize the search queries and/or web page navigation to find a product. Diagram 800 is example diagram of an example generating taxonomies from UoM representations from product descriptions in a product catalog. Generally, and at a high level, products can be categorized based on their UoM representations of a product, such as the dimensions of the product (e.g., categorizing tents based on the size of the tent-10′×10′ or 10′×20′, etc.), which can improve search queries and/or web navigation to find a product. A UoM taxonomy generator that leverages a UoM inference model can be utilized to generate taxonomies (e.g., product categories) for catalogs where attributes related to the UoM representations of the product are important differentiating characteristics of the products.

As shown, the product descriptions 802 for products are input into a UoM inference model 806 (e.g., UoM inference model 304 of FIG. 3). In some embodiments, the products are identified as having zero results in search queries by customers in block 804. As can be understood, the merchandizer may want to identify different attributes of the product in order to improve the discoverability of the product in search engines due to the lack of search results with the product.

UoM inference model 806 outputs inferred UoM name-values pairs with associated context in block 808. For example, the UoM inference model 806 outputs the sizes of various tents of a product catalog (e.g., 10′ length and 10′ width, 10′ foot length and 20′ width, etc.). The inferred UoM name-value pairs are then input into a generative model 810 to generate UoM representation based product taxonomies 812. The generative model 810 utilizes the UoM name value pairs, the context from the product catalog, and/or the UoM representations in zero result queries analyzed for the product along with the query context in order to generate the new attribute names. For example, the generative model 810 utilizing the various name value-pair of sizes of tents, context from the product catalog, and search queries from customers may generate categories for the sizes of tents (e.g., 10′×10′ or 10′×20′, etc.) as customers searched for certain size tents. In some embodiments, the generative model 810 generates a UoM based taxonomy that can be fed as an input to a product classifier to assign categories to products. The new taxonomies or improved existing taxonomies are then provided as recommendations to merchandizer 814. The merchandizer 814 can then approve the UoM based catalog taxonomy/product categorization to enrich the existing catalog with the UoM based catalog taxonomy/product categorization in block 816. In block 818, the product categories are updated with enriched taxonomy to optimize the search queries and/or web page navigation to find a product.

### Exemplary Implementations of Using Machine Learning to Optimize UoM Representations

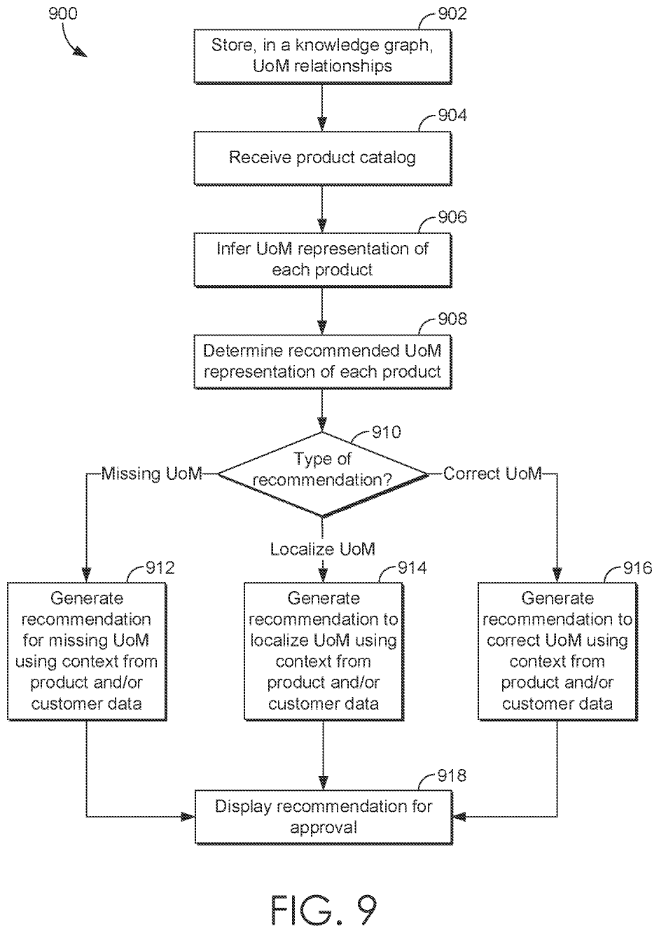

With reference now to FIGS. 9-11, FIGS. 9-11 provide method flows related to facilitating using machine learning to optimize UoM representations, in accordance with embodiments of the present technology. Each block of method 900, 1000 and 1100 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 9-11 are exemplary only and not intended to be limiting. As can be appreciated, in some embodiments, method flows 900-1100 can be implemented, at least in part, to facilitate using machine learning to optimize UoM representations.

Turning to FIG. 9, a flow diagram 900 is provided showing an embodiment of a method 900 for recommending UoM representations to optimize product search queries, in accordance with embodiments described herein. Initially, at block 902, UoM representations and relationships are stored in a knowledge graph (e.g., UoM knowledge graph 302 of FIG. 3). At block 904, a product catalog with product descriptions of products are received. At block 906, an inference model (e.g., UoM inference model 304 of FIG. 3) infers UoM representations of each product based on data within the product description of the product. At block 908, a UoM representation recommender (e.g., UoM representation recommender 306 of FIG. 3) determines the recommended UoM representations for each product to enrich the product description of each product.

At block 910, the UoM representation recommender provides different types of recommendations. If the UoM representation is missing from the product description, at block 912, the UoM representation recommender generates a UoM representation recommendation for the missing UoM representation using context from product and/or customer data (e.g., data 310C of FIG. 3, data 402A of FIG. 4, etc.). If the UoM representation needs to be localized based on the geo-location that the product catalog is being offered, at block 914, the UoM representation recommender generates a UoM representation recommendation to localize the UoM representations using context from product and/or customer data (e.g., data 310C of FIG. 3, data 402A of FIG. 4, etc.). For example, the UoM representation recommender may include a unit converter (e.g., unit converter 306B) to convert the UoM representations between measurement systems. If the UoM representation is incorrect in the product description or its representation can be optimized based on the context of the products/customers, at block 916, the UoM representation recommender generates a UoM representation recommendation to correct or optimize the UoM representation using context from product and/or customer data (e.g., data 310C of FIG. 3, data 402A of FIG. 4, etc.). At block 918, the recommendations is displayed to the business for approval (e.g., through a PIM system).

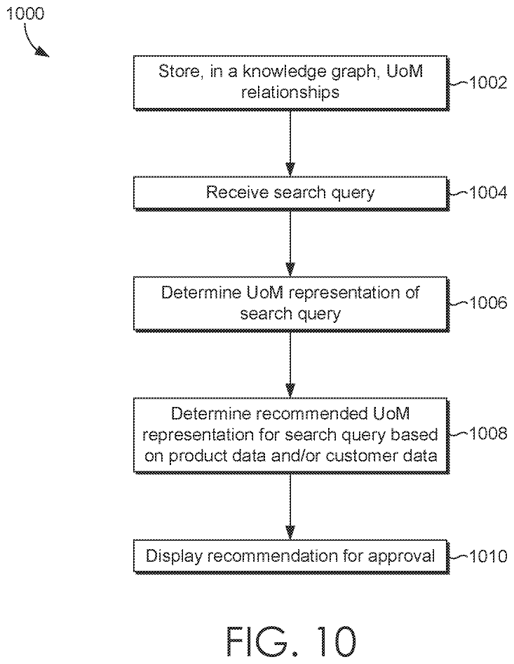

Turning now to FIG. 10, a flow diagram 1000 is provided showing an embodiment of a method 1000 for generating UoM representation suggestions for shopper search queries in order to optimize the search queries, in accordance with embodiments described herein. Initially, at block 1002, UoM representations and relationships are stored in a knowledge graph (e.g., UoM knowledge graph 302 of FIG. 3). At block 1004, a search query is received. At block 1006, an inference model (e.g., UoM inference model 304 of FIG. 3) infers UoM representations in the search query. At block 1008, a UoM representation recommender (e.g., UoM representation recommender 306 of FIG. 3) determines the recommended UoM representations for the search query based on the context, such as the product of the search, product data of the product catalog, customer data, etc. At block 1010, the recommended UoM representations for the search query is displayed for approval by the customer/shopper performing the search query in order to optimize the search query.

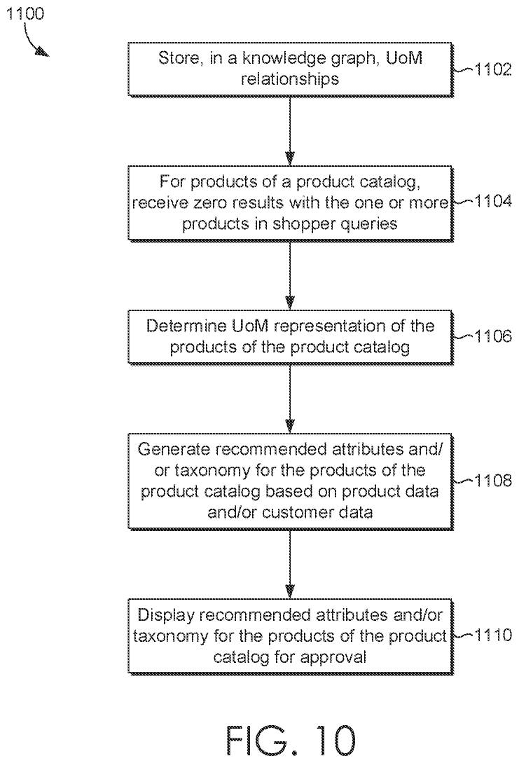

Turning now to FIG. 11, a flow diagram 1100 is provided showing an embodiment of a method 1100 for generating UoM representation attributes and/or taxonomies from product descriptions in order to optimize search query results and/or web page navigation to find a product, in accordance with embodiments described herein. Initially, at block 1102, UoM representations and relationships are stored in a knowledge graph (e.g., UoM knowledge graph 302 of FIG. 3). At block 1104, zero results with one or more products of a product catalog are received in response to search queries by customers. At block 1106, an inference model (e.g., UoM inference model 304 of FIG. 3) infers UoM representations of the one or more products of the product catalog. At block 1108, a UoM representation recommender (e.g., UoM representation recommender 306 of FIG. 3) determines recommended UoM representations as attributes for the products and/or taxonomies (e.g., categories) for the products of the product catalog based on contextual data, such as product data of the product catalog, customer data, etc. At block 1110, the recommended UoM representations as attributes for the products and/or taxonomies (e.g., categories) for the products of the product catalog are displayed for approval by the merchant in order to optimize search query optimize search query results and/or web page navigation to find a product.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 12 in particular, an exemplary operating environment for implementing aspects of the technology described herein is shown and designated generally as computing device 1200. Computing device 1200 is just one example of a suitable computing environment and is not intended to suggest any limitation as to the scope of use or functionality of the technology described herein. Neither should the computing device 1200 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 12, computing device 1200 includes a bus 1210 that directly or indirectly couples the following devices: memory 1212, one or more processors 1214, one or more presentation components 1216, input/output (I/O) ports 1218, I/O components 1220, an illustrative power supply 1222, and a radio(s) 1224. Bus 1210 represents what may be one or more busses (such as an address bus, data bus, or combination thereof). Although the various blocks of FIG. 12 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 12 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 12 and refer to “computer” or “computing device.”

Computing device 1200 typically includes a variety of computer-readable media. Computer-readable media can be any available media that can be accessed by computing device 1200 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1212 includes computer storage media in the form of volatile and/or nonvolatile memory. The memory 1212 may be removable, non-removable, or a combination thereof. Exemplary memory includes solid-state memory, hard drives, and optical-disc drives. Computing device 1200 includes one or more processors 1214 that read data from various entities such as bus 1210, memory 1212, or I/O components 1220. Presentation component(s) 1216 present data indications to a user or other device. Exemplary presentation components 1216 include a display device, speaker, printing component, and vibrating component. I/O port(s) 1218 allow computing device 1200 to be logically coupled to other devices including I/O components 1220, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1214 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 1200. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 1200. The computing device 1200 may be equipped with depth cameras, such as stereoscopic camera systems, infrared camera systems, RGB camera systems, and combinations of these, for gesture detection and recognition. Additionally, the computing device 1200 may be equipped with accelerometers or gyroscopes that enable detection of motion. The output of the accelerometers or gyroscopes may be provided to the display of the computing device 1200 to render immersive augmented reality or virtual reality.

A computing device may include radio(s) 1224. The radio 1224 transmits and receives radio communications. The computing device may be a wireless terminal adapted to receive communications and media over various wireless networks. Computing device 1200 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
storing, in a knowledge graph, a plurality of units of measure (UoMs) and relationships of each of the plurality of UoMs to textual representations of each of the plurality of UoMs;
extracting, by an inference model, text corresponding to a measurement of a product;
determining, by an autoencoder model, a recommended textual representation of the measurement of the product, the recommended textual representation comprising a corresponding textual representation of one of the plurality of UoMs from the textual representations of the plurality of UoMs stored in the knowledge graph; and
causing display of the recommended textual representation of the measurement of the product.

2. The computer-implemented method of claim 1, wherein the relationships of each of the plurality of UoMs comprise at least one of quantitative measure, dimensions, type of measurement system, symbols defined by the type of measurement system, commonly occurring representations, and conversion factors for other measurement systems.

3. The computer-implemented method of claim 1, wherein extracting, by the inference model, the text corresponding to the measurement of the product further comprises:
detecting, by named entity recognition, the text corresponding to the measurement of the product; and
classifying, by a classifier, the text corresponding to the measurement of the product as the one of the plurality of UoMs.

4. The computer-implemented method of claim 3, wherein the classifier is trained based on the relationships of each of the plurality of UoMs and a plurality of product descriptions and wherein the classifier enriches the knowledge graph based on the plurality of product descriptions.

5. The computer-implemented method of claim 3, wherein the classifier is trained to disambiguate between the corresponding textual representation of one of the plurality of UoMs and a different one of the plurality of UoMs with a similar symbol based on a product description.

6. The computer-implemented method of claim 3, wherein the classifier is trained to disambiguate between the corresponding textual representation of the one of the plurality of UoMs when the text contains an erroneous representation of the one of the plurality of UoMs.

7. The computer-implemented method of claim 1, wherein determining, by the autoencoder model, the recommended textual representation of the measurement of the product further comprises:
determining the recommended textual representation of the measurement of the product based on at least one of a location of a customer, a location of a business, a product description in a product catalog of the business, customer data of the customer, business data of the business; and
converting a number in the text corresponding to the measurement of the product to a different number in the corresponding textual representation of one of the plurality of UoMs based on the recommended textual representation of the measurement of the product.

8. The computer-implemented method of claim 1, wherein the autoencoder model is trained based on at least one of product catalogs from different business models, product catalogs from different industry verticals, product catalogs from different locations, the knowledge graph, and search query data.

9. The computer-implemented method of claim 1, further comprising:
receiving a product description of the product, wherein the text corresponding to the measurement of the product is missing a textual representation of a unit of measure (UoM);
classifying, by a classifier, the text corresponding to the measurement of the product as the one of the plurality of UoMs based on the product description of the product; and
determining, by the autoencoder model, the recommended textual representation of the measurement of the product further based on the product description of the product.

10. The computer-implemented method of claim 1, further comprising:
receiving a product description of the product in a plurality of product descriptions of a plurality of products, wherein the text corresponding to the measurement of the product comprises a textual representation of a unit of measure (UoM) that is different from a textual representation of the UoM in a different one of the plurality of products;
classifying, by a classifier, the text corresponding to the measurement of the product as the one of the plurality of UoMs based on the plurality of product descriptions of the product; and
determining, by the autoencoder model, the recommended textual representation of the measurement of the product further based on the plurality of product descriptions of the product.

11. The computer-implemented method of claim 1, further comprising:
receiving a search query for the product with the text corresponding to the measurement of the product; and
determining, by the autoencoder model, the recommended textual representation of the measurement of the product further based on the search query for the product.

12. One or more computer-readable media having a plurality of executable instructions embodied thereon, which, when executed by one or more processors, cause the one or more processors to perform a method comprising:
receiving at least a portion of a search query;
extracting, by an inference model, text corresponding to a measurement in the search query;
determining, by an autoencoder model, a recommended textual representation of the measurement in the search query, the recommended textual representation comprising a corresponding textual representation of one of a plurality of units of measure (UoMs) stored in a knowledge graph; and
causing display of the recommended textual representation of the measurement.

13. The media of claim 12, wherein determining, by the autoencoder model, the recommended textual representation of the measurement is responsive to identifying zero results in response to the search query.

14. The media of claim 12, wherein the corresponding textual representation of the one of the plurality of UoMs is different than a different textual representation of the one of a plurality of UoMs in the text corresponding to the measurement in the search query.

15. The media of claim 12, wherein extracting, by the inference model, the text corresponding to the measurement the search query further comprises:
detecting, by named entity recognition, the text corresponding to the measurement the search query; and
classifying, by a classifier, the text corresponding to the measurement the search query as the one of the plurality of UoMs.

16. The media of claim 12, wherein determining, by the autoencoder model, the recommended textual representation of the measurement in the search query further comprises
determining the recommended textual representation of the measurement in the search query further based on at least one of a product in the search query, a location of a customer, a location of a business, a product description in a product catalog of the business, customer data of the customer, business data of the business.

17. The media of claim 12, wherein determining, by the autoencoder model, the recommended textual representation of the measurement in the search query further comprises:
converting a number in the text corresponding to the measurement of the product to a different number in the corresponding textual representation of one of the plurality of UoMs based on the recommended textual representation of the measurement of the product.

18. A computing system comprising:
a processor; and
a non-transitory computer-readable medium having stored thereon instructions that when executed by the processor, cause the processor to perform operations including:
receiving a product description of a product;
extracting, by an inference model, text corresponding to a measurement of the product in the product description;
determining, by an autoencoder model, a recommended textual representation of the measurement of the product, wherein the recommended textual representation comprises a corresponding textual representation of one of a plurality of units of measure (UoMs) stored in a knowledge graph; and
causing display of the recommended textual representation for the product.

19. The system of claim 18, wherein the instructions that when executed by the processor, cause the processor to perform operations further including:
responsive to identifying zero results for the product in response to a number of search queries:
generating a new recommended textual representation of the measurement of the product based on the search queries; and
causing display of the new recommended textual representation for the product.

20. The system of claim 18, wherein the instructions that when executed by the processor, cause the processor to perform operations further including:
responsive to identifying zero results for the product in response to a number of search queries:
generating taxonomies for one or more sets of products of a plurality of products based on a corresponding textual representation of one of the plurality of UoMs for each product in each of the one or more sets of products of the plurality of products; and
causing display of the taxonomies for the one or more sets of products of the plurality of products.
